(19) United States
(12) Patent Application Publication
(10) Pub. No.: US 2002/0032756 A1
(43) Pub. Date: Mar. 14, 2002

(54) Download system for downloading software or data to terminal

(75) Inventor: Shuzo Toda, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/941,621

(22) Filed: Aug. 30, 2001

(30) Foreign Application Priority Data
Sep. 1, 2000 (JP) 2000-265552

(51) Int. Cl. G06F 15/16

(52) U.S. Cl. 709/219; 709/203

(57) ABSTRACT

This invention allows rewriting the software or data of a terminal without a user's or a maintenance personnel's directly touching the terminal. A center and a terminal are provided. The center has a unit transmitting a download start control signal to the terminal, and a unit transmitting to-be-downloaded software or data to the terminal when receiving a state switching notification signal from the terminal. The terminal has a unit determining whether a received signal is a download start control signal, a unit switching a state of the terminal to a download state if the received signal is the download start control signal, a unit transmitting the state switching notification signal to a sender of the download start control signal when the state of the terminal is changed to the download state, and a unit downloading the software or data after transmitting the download start switch notification signal.

### BACKGROUND OF THE INVENTION

1. Field of the Invention

The present invention relates to a download system for downloading software or data to a terminal. More specifically, the present invention relates to a download system for downloading software or data to a terminal by remote operation from a center.

2. Description of Prior Art

Conventionally, a maintenance personnel actually holds a terminal or the like in hand, connects a cable to the terminal, operates the terminal from externally and performs specific operations to the terminal itself so as to rewrite the software of the terminal or the like, changes data thereof or does other things.

However, a PHS (Personal Handy-phone System) terminal or the like provided to collect data on a gasometer or the like emerging in recent years is disposed in the gap between buildings and on the roof of a building. Due to this, it is often difficult to collect the terminal so as to rewrite the software of the terminal or change the data thereof.

### SUMMARY OF THE INVENTION

It is an object of the present invention to provide a download system for downloading software or data to a terminal, which system allows rewriting the software or data of the terminal without the need for a user or a maintenance personnel to directly touch the terminal.

According to a first aspect of the present invention, there is provided a terminal comprising: means for determining whether a received signal is a download start control signal; means for changing a state of the terminal to a download state if the received signal is the download start control signal; means for transmitting a state switching notification signal to a sender of the download start control signal if the state of the terminal is changed to the download state; and means for downloading one of software and data after transmitting the state switching notification signal.

According to a second aspect of the present invention, there is provided a center comprising: means for transmitting a download start control signal to a terminal; and means or transmitting one of software and data to be downloaded to the terminal, to the terminal when receiving a state switching notification signal from the terminal.

In the above terminal and above center, each of the download start control signal and the state switching notification signal may be transmitted as one of a sub-address, a push button tone and user-to-user information.

According to a third aspect of the present invention, there is provided a system for downloading one of software and data to a terminal comprising the above terminal and the above center.

### BRIEF DESCRIPTION OF THE DRAWINGS

FIG. 1 is a block diagram showing the constitution of a download system for downloading software or data to a terminal in one embodiment according to the present invention in case the terminal is a radio terminal;

FIG. 2 is a block diagram showing the constitution of the download system for downloading software or data to a terminal in one embodiment according to the present invention in case the terminal is an ISDN terminal;

FIG. 3 is a block diagram showing the constitution of the download system for downloading software or data to a terminal in one embodiment according to the present invention in case the terminal is a radio terminal connected to a telemeter;

FIG. 4 is a block diagram showing the constitution of the radio terminal in one embodiment according to the present invention; and

FIG. 5 is a block diagram showing the constitution of the ISDN terminal in one embodiment according to the present invention.

### DETAILED DESCRIPTION OF THE INVENTION

The present invention provides a system for automatically switching the state of a terminal from an ordinary operation state to a downloadable state by transmitting a download start control signal to the terminal in case of changing the software, data or the like of the terminal, which terminal is a mobile radio terminal such as a PHS terminal or an ISDN terminal, or a PHS terminal or the like connected to a telemeter such as a gasometer which emerges in recent years. The software, the data or the like to be downloaded by this system may be a firmware.

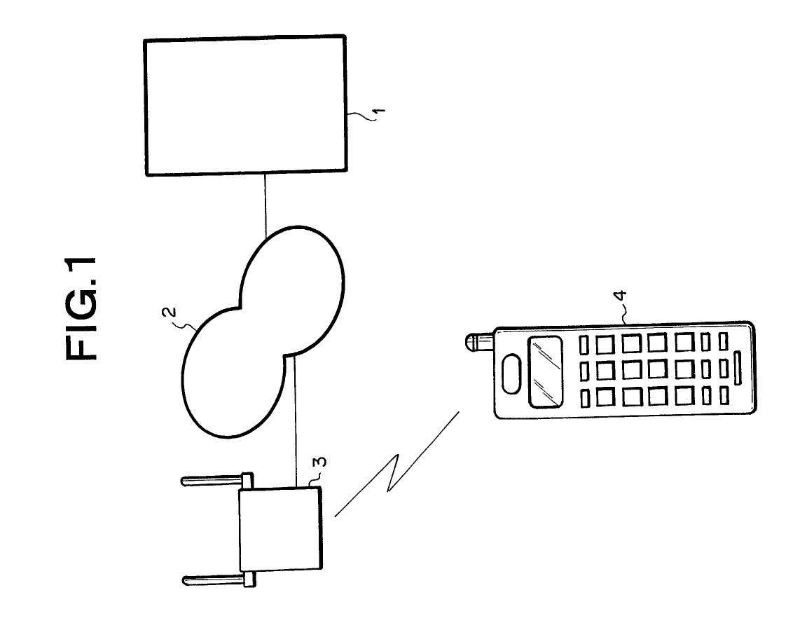

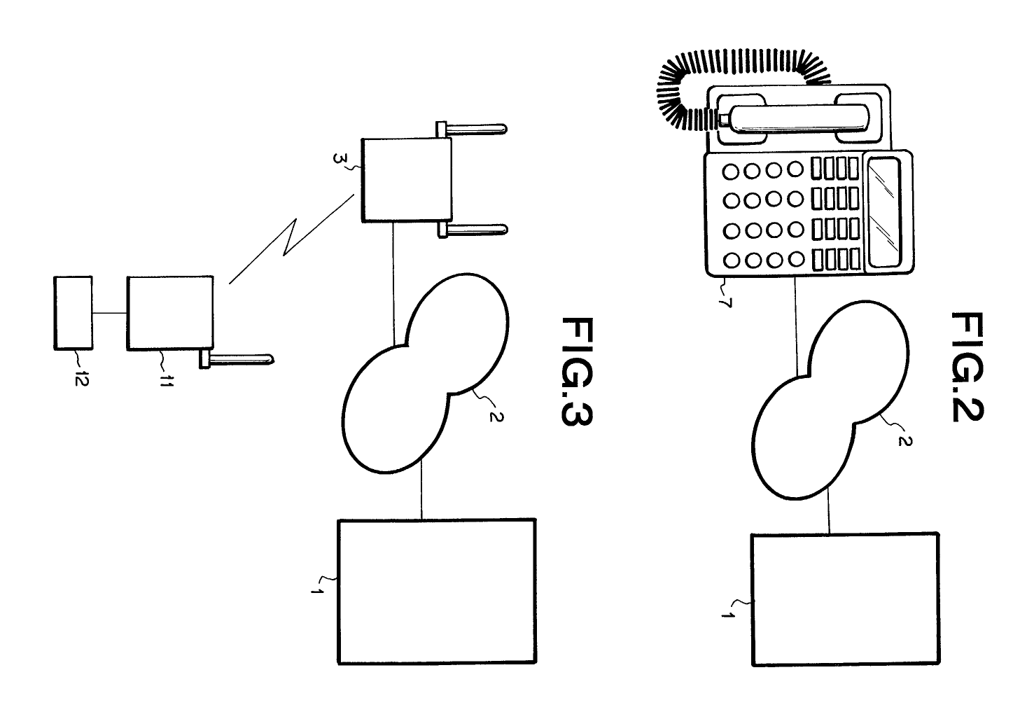

The present system is employed by an ordinary constitution using a radio terminal as shown in FIG. 1, a constitution using an ISDN terminal connected to a line as shown in FIG. 2 or the constitution of a PHS terminal connected to a telemeter or the like as shown in FIG. 3.

Referring to FIG. 1, reference symbol 1 denotes a center, 2 denotes a network, 3 denotes a radio base station and 4 denotes a radio terminal. Referring to FIG. 2, reference symbol 1 denotes a center, 2 denotes a network and 7 denotes an ISDN terminal. Referring to FIG. 3, reference symbol 1 denotes a center, 2 denotes a network, 3 denotes a radio base station, 11 denotes a radio terminal and 12 denotes a telemeter.

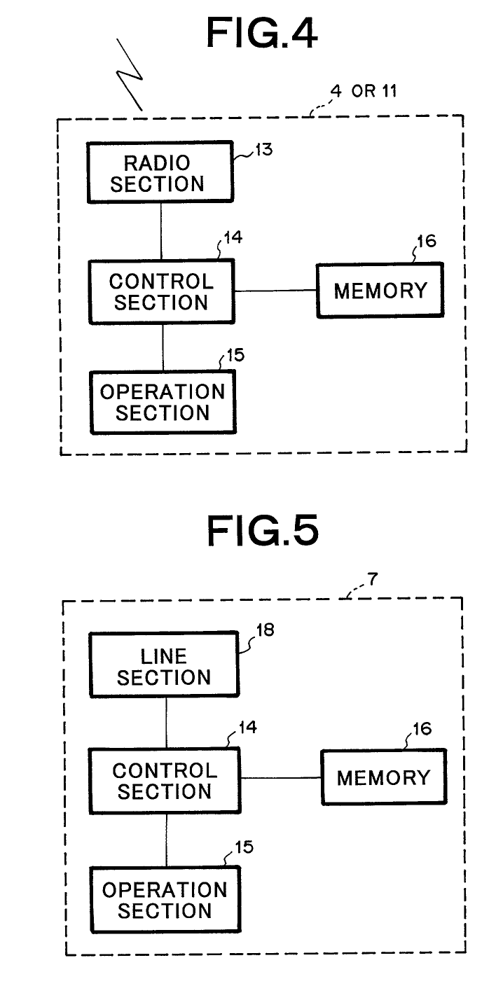

FIG. 4 is a block diagram of the terminal 4 as shown in FIG. 1 or the terminal 11 shown in FIG. 3. FIG. 5 is a block diagram of the terminal 7 as shown in FIG. 2. In FIG. 4 or FIG. 5, data as a download start control signal and a state switching end notification signal are registered with a memory 16 of the terminal 4 or 11. A radio section 13 or a line section 18 receives a signal from the center 1 through the network 2. A control section 14 compares the received signal with signals registered with the memory. If the signal from the center 1 is coincident with the download start control signal registered in advance, the terminal 4, 11 or 7 judges that the signal from the center 1 is a download start control signal. Accordingly, the terminal 4, 11 or 7 starts a software stored in the memory 16 for switching the state of the terminal to a download state.

When switching to the downloadable state is completed, the terminal 4, 11 or 7 reads a state switching end notification signal from the memory 16 and notifies the state switching end notification signal to the center 1 from the radio section 13 or the line section 18 through the network 2. When receiving the state switching end notification signal, the center 1 judges that the state of the terminal 4, 11 or 7 is switched to a download state. Then, the center 1 starts transmitting software or data to the terminal 4, 11 or 7. The terminal 4, 11 or 7 downloads the software or the data transmitted from the center 1 and stores the software or the data in the memory 16.

As one concrete embodiment, there is a method in which a download start control signal and a state switching end notification signal are set as sub-addresses. The sub-address means herein a signal representing additional information transmitted together with telephone number information. The terminal 4, 11 or 7 registers a sub-address “000” as the download start control signal and a sub-address “999” as the state switching end notification signal in the memory 16. To execute downloading, the center 1 calls a terminal 4, 11 or 7 through the network 2 and transmits the sub-address “000” to the terminal 4, 11 or 7. The terminal 4, 11 or 7 receives the sub-address “000” at radio section 13 or the line section 18. The control section 14 compares the received sub-address with the sub-address registered with the memory in advance. As a result of the comparison, since the received sub-address “000” is coincident with the download start control sub-address “000”, the terminal 4, 11 or 7 judges that the sub-address transmitted from the center 1 is a request to switch the state of the terminal to the download state. Next, the terminal 4, 11 or 7 starts a software for switching the state of the terminal to the download state from the memory 16. As soon as the switching of the state is completed, the terminal 4, 11 or 7 calls the center 1, reads the sub-address “999” indicating state switching completion from the memory 17 and transmits the sub-address “999” thus read to the center 1. When receiving the sub-address “999”, the center 1 judges that the terminal 4, 11 or 7 is completed with switch to the download state, and starts transmitting software or data to the terminal 4, 11 or 7. The terminal 4, 11 or 7 downloads the software or the data transmitted from the center 1 and stores the software or the data in the memory 16.

In the above-stated embodiment, the sub-addresses are the download start control signal and the state switching end notification signal, respectively. Alternatively, a PB (Push Button) tone, UUI (User-to user Information) or the like may be used as a download start control signal and a state switching end notification signal. The PB tone means herein the tone of the button, which has been depressed, of the terminal. The UUI means herein a function for exchanging short messages of 128 octets (bytes) or less between users using an ISDN D channel.

According to the present invention, by transmitting the download control signal to the terminal, the ordinary operation state of the terminal can be automatically switched to the downloadable state, and software, data or the like can be automatically downloaded to the terminal. In addition, by employing radio and a line, the center responsible for the maintenance of the terminal can collectively rewrite the software and change the data. This makes it possible to rewrite the software or the data of the terminal without taking the trouble to collect terminals piece by piece.

What is claimed is:

1. A terminal comprising:
means for determining whether a received signal is a download start control signal;
means for changing a state of the terminal to a download state if the received signal is the download start control signal;
means for transmitting a state switching notification signal to a sender of said download start control signal if the state of the terminal is changed to the download state; and
means for downloading one of software and data after transmitting said state switching notification signal.

2. The terminal according to claim 1, wherein
each of said download start control signal and said state switching notification signal is transmitted as one of a sub-address, a push button tone and user-to-user information.

3. A center comprising:
means for transmitting a download start control signal to a terminal; and
means or transmitting one of software and data to be downloaded to said terminal, to said terminal when receiving a state switching notification signal from said terminal.

4. The center according to claim 3, wherein
each of said download start control signal and said state switching notification signal is transmitted as one of a sub-address, a push button tone and user-to-user information.

5. A system for downloading one of software and data to a terminal, comprising the terminal according to claim 1 and the center according to claim 3.

6. A system for downloading one of software and data to a terminal, comprising the terminal according to claim 2 and the center according to claim 4.
